(19) United States
(12) Patent Application Publication
(10) Pub. No.: US 2005/0196149 A1
(43) Pub. Date: Sep. 8, 2005

(54) Method and apparatus for reproducing text subtitle stream files

(76) Inventors: Jea Yong Yoo, Seoul (KR); Kang Soo Seo, Anyang-si (KR); Byung Jin Kim, Seongnam-si (KR); Seung Hoon Lee, Seongnam-si (KR)

Correspondence Address: HARNESS, DICKEY & PIERCE, P.L.C., P.O. BOX 8910, RESTON, VA, 20195, US

(21) Appl. No.: 11/072,428

(22) Filed: Mar. 7, 2005

Related U.S. Application Data
(60) Provisional application No. 60/550,331, filed on Mar. 8, 2004.

(30) Foreign Application Priority Data
Feb. 28, 2005 (KR) 10-2005-0016860

(51) Int. Cl. H04N 5/781

(52) U.S. Cl. 386/95; 386/126

(57) ABSTRACT

Text subtitle streams are reproduced based on register values contained in one or more player status registers included in a player. A SubPlayItem, which designates at least one text subtitle stream and is included in a PlayList recorded on a recording medium, is read. A first register value specifying one of the at least one text subtitle stream is stored in a first player status register included in the player. Next, a second register contained in a second player status register included in the player is read to determine whether the player is capable of decoding text subtitle streams. If the player's decoding capability is indicated, the text subtitle stream specified by the first register value is decoded.

This application claims the benefit of the Korean Patent Application No. 10-2005-0016860, filed on Feb. 28, 2005, which is hereby incorporated by reference as if fully set forth herein.

This application claims the benefit of the U.S. Provisional Application No. unkown, in the name of inventors Kang Soo SEO, Byung Jin JIM, Jea Yong YOO, and Seung Hoon LEE, entitled “PLAYBACK PROCEDURE BASED ON PLAYER STATUS REGISTER (PSRs)”, which is hereby incorporated by reference as if fully set forth herein.

### BACKGROUND OF THE INVENTION

1. Field of the Invention

The present invention relates to a recording medium, and more particularly, to method and apparatus for reproducing text subtitle stream files. Although the present invention is suitable for a wide scope of applications, it is particularly suitable for efficiently reproducing the text subtitle streams.

2. Discussion of the Related Art

Optical discs are widely used as an optical recording medium for recording mass data. Presently, among a wide range of optical discs, a new recording medium, such as a Blu-ray Disc (hereafter referred to as “BD”), is under development for writing and storing high definition video and audio data. Currently, global standard technical specifications of the Blu-ray Disc (BD), which is known to be the next generation technology, are under establishment as a next generation optical recording solution that is able to have a data significantly surpassing the conventional DVD, along with many other digital apparatuses.

Accordingly, optical reproducing apparatuses having the Blu-ray Disc (BD) standards applied thereto are also being developed. However, since the Blu-ray Disc (BD) standards are yet to be completed, there have been many difficulties in developing a complete optical reproducing apparatus. Particularly, in order to effectively reproduce the data from the Blu-ray Disc (BD), not only should the main AV data as well as various data required for a user's convenience, such as subtitle information as the supplementary data related to the main AV data, be provided, but also managing information for reproducing the main data and the subtitle data recorded in the optical disc should be systemized and provided. However, in the present Blu-ray Disc (BD), since preferred reproducing methods for reproducing the supplementary data and, most particularly, text subtitle stream files are not completely developed, there are many restrictions in the full-scale development of a Blu-ray Disc (BD) basis optical reproducing apparatus.

### SUMMARY OF THE INVENTION

Accordingly, the present invention is directed to a method and apparatus for reproducing text subtitle stream files that substantially-obviate one or more problems due to limitations and disadvantages of the related art.

Additional advantages, objects, and features of the invention will be set forth in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for reproducing text subtitle streams for a player includes reading a SubPlayItem included in a PlayList recorded on a recording medium, the SubPlayItem designating at least one text subtitle stream, storing a first register value in a first player status register included in the player, the first register value specifying one of the at least one text subtitle stream, reading a second register value contained in a second player status register included in the player, the second register value indicating whether the player is capable of decoding text subtitle streams, and decoding the text subtitle stream specified by the first register value if the second register value indicates the player's decoding capability.

In another aspect of the present invention, an apparatus for reproducing text subtitle streams includes a playback system, which includes a first player status register containing a first register value specifying one of at least one text subtitle stream designated by a SubPlayItem, the SubPlayItem being included in a PlayList recorded on a recording medium, a second player status register containing a second register value indicating whether the playback system is capable of decoding text subtitle streams, and a decoder configured to decode the text subtitle stream specified by the first register if the second register value indicates the decoding capability, and a controller configured to receive one or more operation commands from a user, and to control operation of the playback system according to the operation commands.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a structure of the data files recorded in an optical disc according to the present invention;

FIG. 2 illustrates data storage areas of the optical disc according to the present invention;

FIG. 3 illustrates a text subtitle and a main image presented on a display screen according to the present invention;

FIG. 4 illustrates a schematic diagram illustrating reproduction control of a text subtitle stream according to the present invention;

FIG. 5 illustrates an optical recording and/or reproducing apparatus according to the present invention;

FIG. 6 illustrates various types of Player Status Registers (PSRs) included in the optical recording and/or reproducing apparatus according to the present invention;

FIGS. 7A to 7C illustrate structures of each PSR related to the reproduction of the text subtitle stream file according to the present invention; and

FIGS. 8 and 9 illustrate a method for reproducing text subtitle stream files according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

In this detailed description, “recording medium” refers to all types of medium that can record data and broadly includes all types of medium regardless of the recording method, such as an optical disc, a magnetic tape, and so on. Hereinafter, for simplicity of the description of the present invention, the optical disc and, more specifically, the “Blu-ray disc (BD)” will be given as an example of the recording medium proposed herein. However, it will be apparent that the spirit or scope of the present invention may be equally applied to other types of recording medium.

In this detailed description, “main data” represent audio/video (AV) data that belong to a title (e.g., a movie title) recorded in an optical disc by an author. In general, the AV data are recorded in MPEG2 format and are often called AV streams or main AV streams. In addition, “supplementary data” represent all other data required for reproducing the main data, examples of which are text subtitle streams, interactive graphic streams, presentation graphic streams, and supplementary audio streams (e.g., for a browsable slideshow). These supplementary data streams may be recorded in MPEG2 format or in any other data format. They could be multiplexed with the AV streams or could exist as independent data files within the optical disc.

A “subtitle” represents caption information corresponding to video (image) data being reproduced, and it may be represented in a predetermined language. For example, when a user selects an option for viewing one of a plurality of subtitles represented in various languages while viewing images on a display screen, the caption information corresponding to the selected subtitle is displayed on a predetermined portion of the display screen. If the displayed caption information is text data (e.g., characters), the selected subtitle is often called a “text subtitle”. According to one aspect of the present invention, a plurality of text subtitle streams in MPEG2 format may be recorded in an optical disc, and they may exist as a plurality of independent stream files. Each “text subtitle stream file” is created and recorded within an optical disc. And, the purpose of the present invention is to provide a method and apparatus for reproducing the recorded text subtitle stream file.

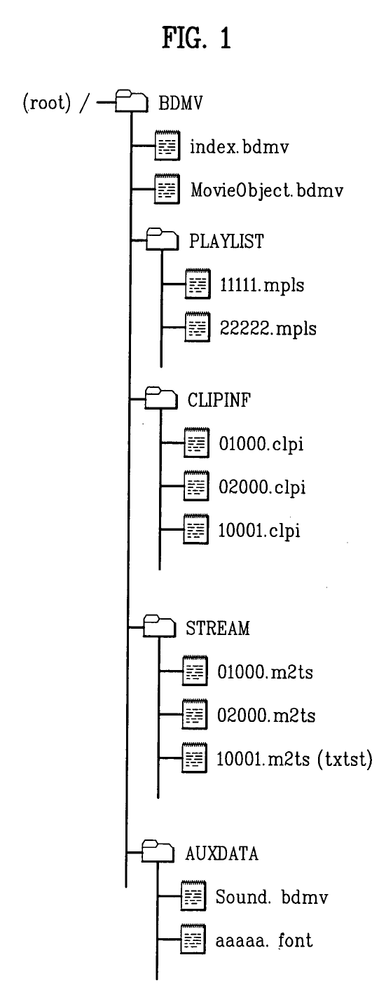

FIG. 1 illustrates a file structure of the data files recorded in a Blu-ray disc (hereinafter referred to as “BD”) according to the present invention. Referring to FIG. 1, at least one BD directory (BDMV) is included in a root directory (root). Each BD directory includes an index file (index.bdmv) and an object file (MovieObject.bdmv), which are used for interacting with one or more users. For example, the index file may contain data representing an index table having a plurality of selectable menus and movie titles. Each BD directory further includes four file directories that include audio/video (AV) data to be reproduced and various data required for reproduction of the AV data.

The file directories included in each BD directory are a stream directory (STREAM), a clip information directory (CLIPINF), a playlist directory (PLAYLIST), and an auxiliary data directory (AUX DATA). First of all, the stream directory (STREAM) includes audio/video (AV) stream files having a particular data format. For example, the AV stream files may be in the form of MPEG2 transport packets and be named as “*.m2ts”, as shown in FIG. 1. The stream directory may further include one or more text subtitle stream files, where each text subtitle stream file includes text (e.g., characters) data for a text subtitle represented in a particular language and reproduction control information of the text data. The text subtitle stream files exist as independent stream files within the stream directory and may be named as “*.m2ts” or “*.txtst”, as shown in FIG. 1. An AV stream file or text subtitle stream file included in the stream directory is often called a clip stream file.

Next, the clip information directory (CLIPINF) includes clip information files that correspond to the stream files (AV or text subtitle) included in the stream directory, respectively. Each clip information file contains property and reproduction timing information of a corresponding stream file. For example, a clip information file may include mapping information, in which presentation time stamps (PTS) and source packet numbers (SPN) are in a one-to-one correspondence and are mapped by an entry point map (EPM), depending upon the clip type. Using the mapping information, a particular location of a stream file may be determined from a set of timing information (In-Time and Out-Time) provided by a PlayItem or SubPlayItem, which will be discussed later in more details. In the industry standard, each pair of a stream file and its corresponding clip information file is designated as a clip: For example, 01000.clpi included in CLIPINF includes property and reproduction timing information of 01000.m2ts included in STREAM, and 01000.clpi and 01000.m2ts form a clip.

Referring back to FIG. 1, the playlist directory (PLAYLIST) includes one or more PlayList files (*.mpls), where each PlayList file includes at least one PlayItem that designates at least one main AV clip and the reproduction time of the main AV clip. More specifically, a PlayItem contains information designating In-Time and Out-Time, which represent reproduction begin and end times for a main AV clip designated by Clip_Information_File_Name within the PlayItem. Therefore, a PlayList file represents the basic reproduction control information for one or more main AV clips. In addition, the PlayList file may further include a SubPlayItem, which represents the basic reproduction control information for a text subtitle stream file. When a SubPlayItem is included in a PlayList file to reproduce one or more text subtitle stream files, the SubPlayItem is synchronized with the PlayItem(s). On the other hand, when the SubPlayItem is used to reproduce a browsable slideshow, it may not be synchronized with the PlayItem(s). According to the present invention, the main function of a SubPlayItem is to control reproduction of one or more text subtitle stream files.

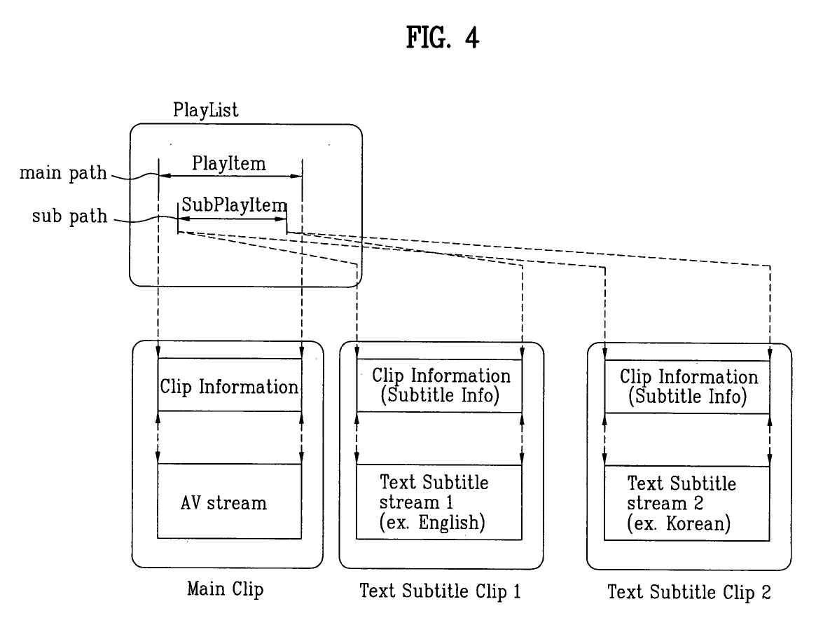

Accordingly, a path reproducing the main data by using at least one PlayItem within a PlayList file is called a main path. And, the path reproducing the text subtitle stream file as the supplementary data is called a sub path. More specifically, a main path must be included in a PlayList file, and, when corresponding supplementary data exist, at least one sub path is provided for each supplementary data property. The reproduction of the text subtitle stream file using the main path and the sub path will be described in more, detail in a later process with reference to FIG. 4. Lastly, the auxiliary data directory (AUX DATA) may include supplementary data stream files, examples of which are font files (e.g., aaaaa.font or aaaaa.otf), pop-up menu files (not shown), and sound files (e.g., Sound.bdmv) for generating click sound. The text subtitle stream files mentioned earlier may be included in the auxiliary data directory instead of the stream directory.

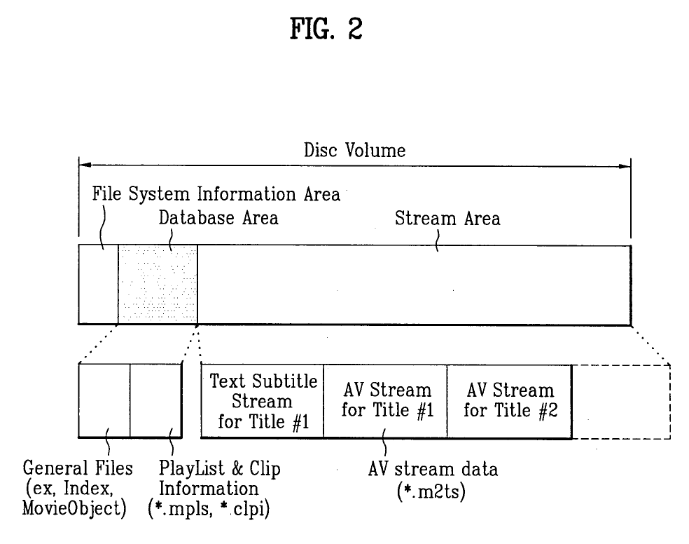

FIG. 2 illustrates data storage areas of an optical disc according to the present invention. Referring to FIG. 2, the optical disc includes a file system information area occupying the inmost portion of the disc volume, a stream area occupying the outmost portion of the disc volume, and a database area occupied between the file system information area and the stream area. In the file system information area, system information for managing the entire data files shown in FIG. 1 is stored. Next, main data and supplementary data (i.e., AV streams and one or more text subtitle streams) are stored in the stream area. The main data may include audio data, video data, and graphic data. And, the supplementary data (i.e., the text subtitle) is independently stored in the stream area without being multiplexed with the main data. The general files, PlayList files, and clip information files shown in FIG. 1 are stored in the database area of the disc volume. As discussed above, the general files include an index file and an object file, and the PlayList files and clip information files include information required to reproduce the AV streams and the text subtitle streams stored in the stream area. Using the information stored in the database area and/or stream area, a user is able to select a specific playback mode and to reproduce the main AV and text subtitle streams in the selected playback mode.

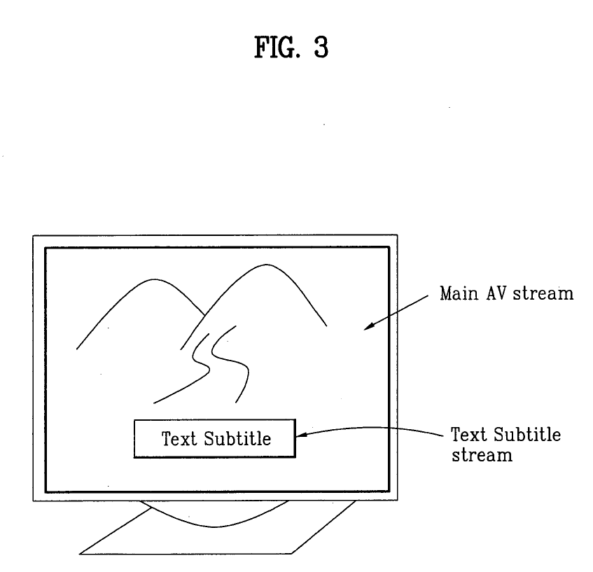

FIG. 3 illustrates a text subtitle and a main image presented on a display screen according to the present invention. The main image and the text subtitle are simultaneously displayed on the display screen when a main AV stream and a corresponding text subtitle stream are reproduced in synchronization. Accordingly, the text subtitle data must be provided in synchronization with the main data. And, a method for synchronizing the text subtitle data with the main data and a method for realizing random access will be proposed in the description of the present invention.

FIG. 4 is a schematic diagram illustrating reproduction control of a main clip and text subtitle clips according to the present invention. Referring to FIG. 4, a PlayList file includes at least one PlayItem controlling reproduction of the main data (i.e., the main clip), and a SubPlayItem controlling reproduction of a plurality of text subtitle clips using the sub path, when a text subtitle corresponding to the main data is included. Reproduction of each of text subtitle clip 1 and text subtitle clip 2, shown in FIG. 4, for English and Korean text subtitles is controlled by a SubPlayItem. And, since the text subtitle clip 1 for English and the text subtitle clip 2 for Korean are synchronized with the main data, the text subtitle clips may be simultaneously displayed on a display screen along with the main data at a particular presentation time.

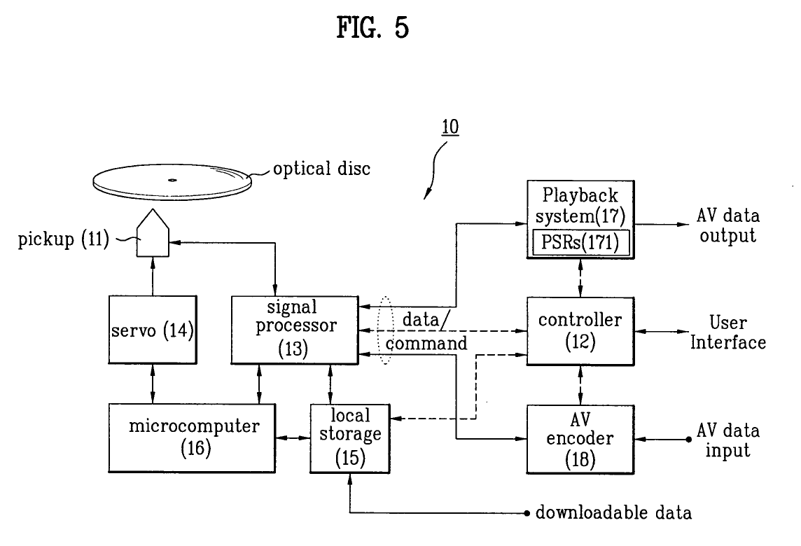

FIG. 5 illustrates an optical recording and/or reproducing apparatus 10 according to the present invention. In the present invention, an “optical recording and/or reproducing apparatus” refers to an entire system or apparatus for either recording data within a recording medium, such as the blu-ray disc (BD), or reproducing recorded data from the recording medium. If the apparatus is able to perform reproducing operations, as described in the present invention, the optical recording and/or reproducing apparatus may be referred to as a “player”. And, when the apparatus is applied as a peripheral device of a personal computer (PC), the apparatus may be referred to as a “drive”. Therefore, the optical recording and/or reproducing apparatus 10 according to the present invention will refer to both a “player” and a “device”.

The optical recording and/or reproducing apparatus 10 basically includes a pick-up unit 11 for reading control information including data and reproduction control file information recorded within an optical disc, a servo 14 controlling the operations of the pick-up unit 11, a signal processor 13 either recovering the playback signal received from the pick-up unit 11 to a desired signal value, or modulating a signal to be recorded to an optical disc recordable signal and transmitting the modulated signal, and a microcomputer 16 controlling the pickup unit 11, the servo 14, and the signal processor 13. Herein, the pickup unit 11, the servo 14, the signal processor 13, and the microcomputer 16 are collectively referred to as a recording and/or reproducing unit or a drive. Also, the optical recording and/or reproducing apparatus 10 further includes a local storage 15. The local storage 15 downloads data from an external source and stores the downloaded data, thereby enabling the downloaded and stored data to be reproduced with the optical disc.

In addition, as described above, a playback system 17 is a playback (or reproduction) unit for playing-back (or reproducing) the disc along with the data within the local storage. However, the playback system 17 is not necessarily required to be included in the optical recording and/or reproducing apparatus 10 according to the present invention, and so the present invention will not be limited to the above-described structure. The playback system 17 downloads the data existing in an external source and stores the downloaded data into the local storage 15. At the same time, the playback system 17 configures a virtual file system (VFS) for reproducing (or playing-back) the data within the optical disc (hereinafter referred to as an “original data” for simplicity) and the data within the local storage (hereinafter referred to as an “additional data” for simplicity). Then, the playback system 17 creates a virtual package having all of the original data and the corresponding additional data included therein through the virtual file system. Thereafter, the playback system 17 uses the virtual package to reproduce the original data and/or the additional data in accordance with the user's request.

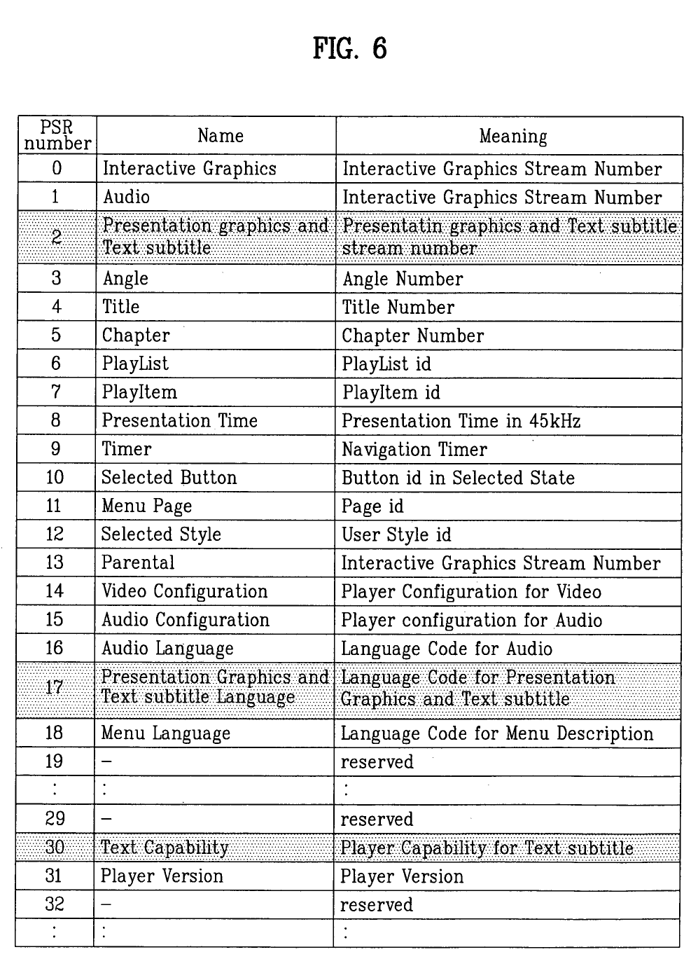

Most particularly, it is apparent that when a text subtitle stream is included as the additional data, the method and apparatus for reproducing the text subtitle stream files according to the present invention may also be applied identically as when reproducing the text subtitle stream file included in the local storage. Accordingly, the playback system 17 includes a plurality of player status registers (PSRs) 171, which will be used when reproducing a loaded disc, and which will be described in detail with reference to FIG. 6. And, in order to perform the function of recording a signal on the optical disc, an AV encoder 18 converts an input signal into a signal of a specific format (e.g., an MPEG-2 transport stream) depending upon the controls of a controller 12 and, then, provides the converted signal to the signal processor 13. The controller 12 controls the overall operations of the optical recording and/or reproducing apparatus 10. More specifically, the controller 12 receives a user command through interactivity with the user and uses the received user command for controlling the operations of each member part of the apparatus 10.

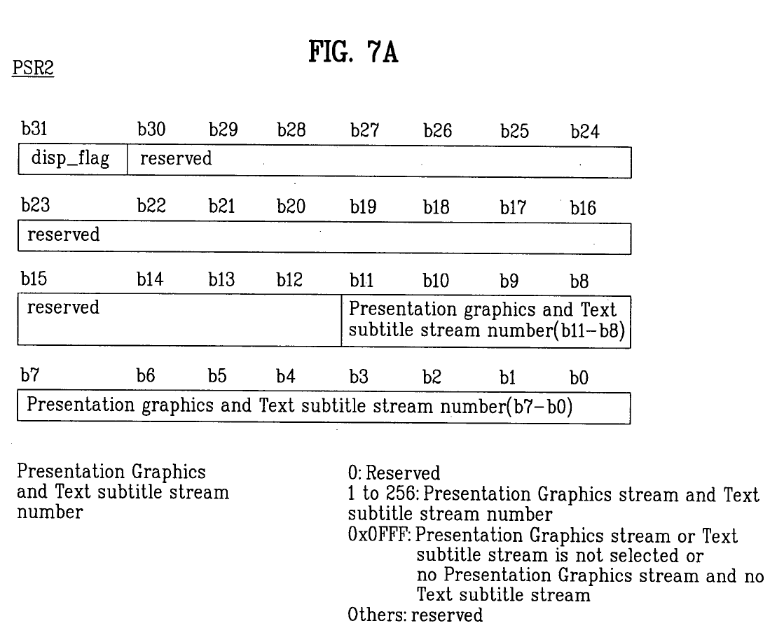

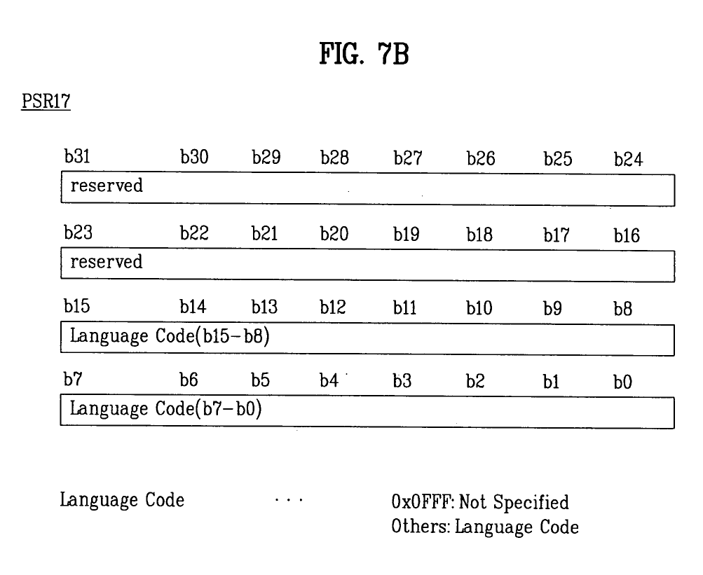

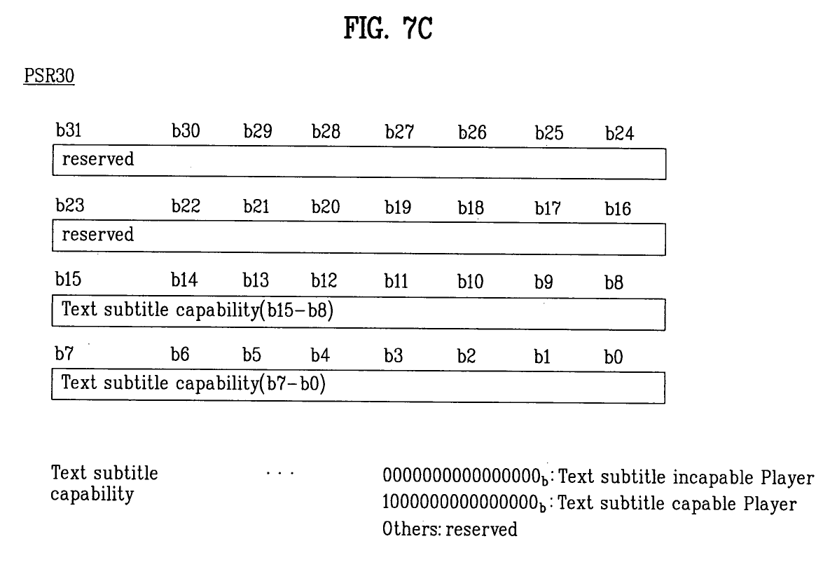

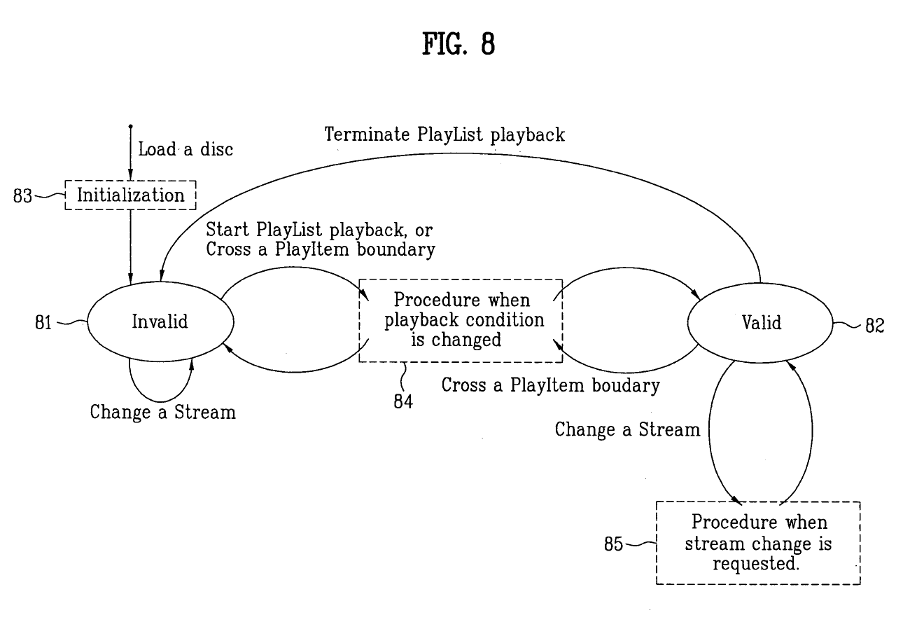

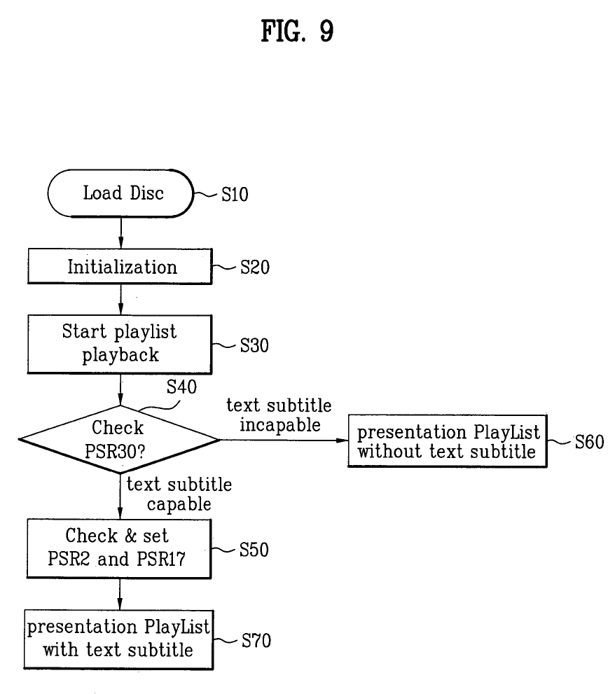

Hereinafter, the method for reproducing the text subtitle stream file according to the present invention will now be described in detail with reference with the accompanying drawings. FIG. 6 illustrates various types of player status registers (PSRs) included in the playback system 17 according to the present invention. FIGS. 7A to 7C illustrate structures of each PSR related to the reproduction of the text subtitle stream file according to the present invention. And, FIGS. 8 and 9 illustrate a method for reproducing text subtitle stream files according to the present invention.

As described above, FIG. 6 illustrates various types of player status registers (PSRs) that are used when reproducing the optical disc. More specifically, the optical recording and/or reproducing apparatus 10 refers to a set of values designated within each PSR, which are included in the playback system 17, so as to reproduce the optical disc. Most particularly, the player status registers (PSRs) may be largely described into two types. PSR0 to PSR12 are referred to as “Playback Status Registers”, and PSR13 to PSR30 are referred to as “Player Setting Registers”. Herein, each of the PSRs is configured to have 32 bits.

Accordingly, the playback status registers (i.e., PSR0 to PSR12) are configured with information representing the status of an optical disc currently being reproduced. For example, an Interactive graphics Stream Number- currently being reproduced is, recorded in PSR0, and an Audio Stream number being reproduced is recorded in PSR1. A Presentation graphics and Text subtitle stream Number being reproduced is recorded in PSR2, and an Angle Number being reproduced is recorded in PSR3. A Title Number being reproduced is recorded in PSR4, a Chapter Number being reproduced is recorded in PSR5, a PlayList id being reproduced is recorded in PSR6, and a PlayItem id being reproduced is recorded in PSR7. Presentation time information (e.g., presentation time and Navigation Timer) are recorded in PSR8 and PSR9. And, a button id is selected state is recorded in PSR10, a Menu page id being reproduced is recorded in PSR11, and a User Style id of the text subtitle stream file being reproduced is recorded in PSR12. More specifically, when the optical disc is loaded, the Playback Status Registers (PSR0 to PSR12) are respectively assigned with initial values, which have been pre-decided during an initialization step. The initial values assigned to each PSR may vary in accordance with a selection of presentation stream (or reproduction stream) or presentation method (or reproduction method) made by the user.

Further, the playback setting registers (i.e., PSR13 to PSR31) are configured with information representing the presentation status of an optical recording and/or reproducing apparatus. For example, a Parental level information is recorded in PSR13 for children under the age of 18, and a Player configuration for video representing a display aspect ratio of a video data being reproduced is recorded in PSR14. A Player configuration for audio of a presentable audio format (e.g., whether LPCM, AC-3, and DTS decoding can be performed) us recorded in PSR15, and a Language code of an audio data, a text subtitle stream, and a menu information is each recorded in PSR16 to PSR18, respectively. A Player capability for Text Subtitle is recorded in PSR30, and information indicating a Player Version of the optical recording and/or reproducing apparatus is recorded in PSR31. More specifically, the present invention is related to the presentation (or reproduction) of a text subtitle stream. Hereinafter, among the above-mentioned PSRS, PSR2, PSR17, and PSR30, which are directly related with the presentation of the text subtitle stream, will now be described in detail.

FIG. 7A illustrates PSR2 (i.e., the Presentation graphics and Text subtitle stream Number) being configured with 32 bits. More specifically, referring to FIG. 7A, when one of the 32 bits (e.g., “b31”) creates a “disp_flag” and when the corresponding bit is “1b”, the display of the text subtitle stream is enabled. Conversely, when the corresponding bit is “0b”, the display of the text subtitle stream is disabled. In addition, among the 32 bits, 12 bits (e.g., “b11” to “b0”) records Presentation graphics and Text subtitle stream numbers that are currently being presented (or reproduced). In the recent BD standard, a total of 256 independent text subtitle streams can be formed, and so the stream numbers that can be validly designated range from “1” to “256”. More specifically, PSR2 indicates the text subtitle stream that is currently being reproduced (or that is to be reproduced). Therefore, when the value of PSR2 varies, the text subtitle stream that is being reproduced may vary accordingly. In addition, when the initial value designated to PSR2 is not the text subtitle stream number within the loaded optical disc, a process of modifying the PSR2 to a reproducible value is required.

FIG. 7B illustrates PSR17 (i.e., the Language code for Presentation graphics and Text subtitle stream) being configured with 32 bits. More specifically, referring to FIG. 7B, among the 32 bits, information of the language code of the presentation graphic or text subtitle stream that is currently being reproduced is recorded in 16 bits (e.g., “b15” to “b0”). In the 16 bits, the language codes are recorded by indicating each language by two characters, such “K” for Korean, “EN” for English, and “JP” for Japanese. Therefore, a specific language information (or language code), which is selected by the user, is recorded in PSR17.

FIG. 7C illustrates PSR30 (i.e., the Player capability for Text subtitle stream) being configured with 32 bits. More specifically, PSR30 is a predetermined value deciding whether the corresponding optical recording and/or reproducing apparatus 10 has reproducing capability. Unlike the presentation graphic of the current BD standard, which must have reproducing capability, the reproducing capability of the text subtitle stream may be optional. Accordingly, the reproducing capability of the text subtitle stream is required only for responding to a request for reproducing the text subtitle stream, the request being made by the user. Therefore, the optical recording and/or reproducing apparatus 10 first verifies (or checks) the PSR30, thereby determining whether reproduction of the text subtitle stream can be supported.

Among the 32 bits of PSR30, 16 bits (e.g. “b15” to “b0”) are used as information indicating the capability of reproducing the text subtitle stream. For example, when all of “b15” to “b0” are equal to ‘0’, the text subtitle stream is incapable of being reproduced. Conversely, when only “b15” is equal to ‘1’, among the 16 bits “b15” to “b0”, and the rest of the bits is equal to ‘0’, the text subtitle stream is capable of being reproduced. The bit column indicating PSR30 is only an example of the present invention. It is apparent that other bit columns may be selected for indicating the “capability” and the “incapability” of reproducing the text subtitle stream according to the present invention.

FIGS. 8 and 9 illustrate a method for reproducing text subtitle stream files according to the present invention. Referring to FIG. 8, the status of the load optical disc that is being reproduced can be described as 2 general states and 3 temporal states. The elliptic circles drawn in a solid line represent the 2 general states of the optical disc, which is more specifically described as a valid state 82 and an invalid state 81. Also, the boxes drawn in a dotted line represent the 3 temporal states of the optical disc. More specifically, the dotted boxes represent an initialization state 83, a procedure when the playback (or reproduction) condition is changed 84, and a procedure when a stream change is requested 85.

In the general states, the valid state 82 refers to when the text subtitle stream is reproduced normally, and the invalid state 83 refers to when a PlayList reproduction command is not given or when a valid text subtitle stream does not exist. More specifically, in order to perform a transition between the valid state 82 and the invalid state 81, a status transition is required. The status transition occurs when playback (or reproduction) is requested, or when a playback (or reproduction) condition is changed in accordance to a user command. Moreover, in the temporal states, after determining or verifying a status of a player that is suitable for the corresponding temporal state, a transition to one of the valid state 82 and the invalid state 81 is immediately performed.

For example, in the temporal state, the initialization status 83 refers to when an entire system within the optical recording and/or reproducing apparatus 10 is initialized for the recording/reproducing of the optical disc, once the optical disc is loaded. More specifically, in reproducing the text subtitle stream, the above-described PSR2 is set to be “0x0FFF”, thereby indicating that the text subtitle stream has not yet been selected and is on stand-by as an invalid state 81 in a later process. Additionally, in the temporal state, the procedure when the playback condition is changed 84 refers to a status when a transition of the valid state 82 and the invalid state 81 may occur. For example, in case of the text subtitle stream, when a specific start PlayList playback command is given in the invalid state 81, the playback capability of the text subtitle stream defined in the PlayList is verified in accordance with the value assigned to the above-described PSR30 (i.e., the Player capability for Text subtitle stream). When playback is capable, the status is transited to the valid state 82. Conversely, when playback is incapable, the status is remained as the invalid state 81.

More specifically, when PSR30 is capable of being reproduced (or played-back), the text subtitle stream number designated within PSR2 (i.e., the Presentation graphics and Text subtitle stream Number) is determined, in a later process, to designate any one of the text subtitle streams existing in the optical disc. Thereafter, in order to reproduce the text subtitle stream corresponding to the text subtitle stream number designated to the corresponding PSR2 is transited to be in the valid state 82. Furthermore, in the temporal state, the procedure when a stream change is requested 85 refers to a status when s change occurs from the valid state 82 to a new stream. In other words, as shown in FIG. 4, 2 text subtitle streams (Clip #1 and Clip #2) exist, and while reproducing Clip #1 (English), the text subtitle stream can be changed to Clip #2 (Korean) in accordance with the user's request. Most particularly, the language code of the text subtitle stream being reproduced is determined by designating character codes representing the corresponding language to PSR17 (i.e., the Language code for Presentation graphics and Text subtitle stream).

FIG. 9 illustrates a flow chart of the process of reproducing the text subtitle stream according to the present invention, shown in FIG. 8. When the optical disc is loaded (S10), an initialization process is performed (S20). Then, the reproduction (or presentation) of a selected PlayList is initiated (S30). Accordingly, when the text subtitle stream is included in the PlayList, PSR30 is verified, so as to determine whether the text subtitle stream is capable of being played-back by the corresponding player (S40). If the text subtitle stream is determined to be capable for playback, the corresponding player verifies (or determines), through PSR2, a text subtitle stream number within the optical disc that is to be reproduced and, then, verifies the corresponding language code through PSR17 (S50). Thereafter, the main data of the PlayList is reproduced along with the text subtitle stream (S70). Conversely, if the text subtitle stream is determined to be incapable for playback, the corresponding player excludes the text subtitle stream and only reproduces the main data of S60). In this case, it is preferable to display a guidance message or transmit a voice message to the user indicating that playback of the text subtitle stream cannot be performed.

As described-above, the method and apparatus for reproducing the text subtitle stream files according to the present invention is advantageous in that the text subtitle stream can be reproduced with more efficiency.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method for reproducing text subtitle streams for a player, the method comprising:
reading a SubPlayItem included in a PlayList recorded on a recording medium, the SubPlayItem designating at least one text subtitle stream;
storing a first register value in a first player status register included in the player, the first register value specifying one of the at least one text subtitle stream;
reading a second register value contained in a second player status register included in the player, the second register value indicating whether the player is capable of decoding text subtitle streams; and
decoding the text subtitle stream specified by the first register value if the second register value indicates the player's decoding capability.

2. The method of claim 1, further comprising initializing a plurality of player status registers including the first and second player status registers when the recording medium is loaded by the player.

3. The method of claim 2, wherein the plurality of player status registers comprise at least one playback status register storing playback status parameters and at least one player setting register storing player configuration parameters.

4. The method of claim 1, wherein the at least one text subtitle stream designated by the SubPlayItem is pre-recorded on the recording medium.

5. The method of claim 1, wherein the at least one text subtitle stream designated by the SubPlayItem is pre-stored in a local storage included in the player.

6. The method of claim 5, wherein the at least one text subtitle stream stored in the local storage is downloaded from an external source.

7. The method of claim 1, wherein the first player status register further includes a flag indicating whether display of text subtitle streams is enable or disable.

8. The method of claim 1, further comprising storing a third register value in a third player status register, the third register value indicating a language code of the text subtitle stream specified by the first register value.

9. The method of claim 1, further comprising, if the second register value indicates the player is incapable of decoding text subtitle streams, notifying the player's a decoding incapability to one or more users.

10. A method for reproducing AV streams and text subtitle streams for a player, the method comprising:
reading a PlayItem and a SubPlayItem included in a PlayList recorded in a recording medium, the PlayItem designating a main AV stream recorded on the recording medium and the SubPlayItem designating at least one text subtitle stream;
storing a first register value in a first player status register included in the player, the first register value specifying one of the at least one text subtitle stream;
reading a second register value contained in a second player status register included in the player, the second register value indicating whether the player is capable of decoding text subtitle streams; and
decoding the main AV stream designated by the PlayItem and the text subtitle stream specified by the first register value if the second register value indicates the player's decoding capability.

11. The method of claim 10, wherein the at least one text subtitle stream designated by the SubPlayItem is pre-recorded on the recording medium.

12. The method of claim 10, wherein the at least one text subtitle stream designated by the SubPlayItem is pre-stored in a local storage included in the player.

13. An apparatus for reproducing text subtitle streams, the apparatus comprising:
a playback system, which comprises:
a first player status register containing a first register value specifying one of at least one text subtitle stream designated by a SubPlayItem, the SubPlayItem being included in a PlayList recorded on a recording medium;
a second player status register containing a second register value indicating whether the playback system is capable of decoding text subtitle streams; and
a decoder configured to decode the text subtitle stream specified by the first register if the second register value indicates the decoding capability; and
a controller configured to receive one or more operation commands from a user, and to control operation of the playback system according to the operation commands.

14. The apparatus of claim 13, the first and second player status registers are initialized when the recording medium is loaded.

15. The apparatus of claim 13, wherein the at least one text subtitle stream designated by the SubPlayItem is pre-recorded on the recording medium.

16. The apparatus of claim 13, further comprising a local storage configured to pre-store the at least one text subtitle stream designated by the SubPlayItem.

17. The apparatus of claim 16, wherein the at least one text subtitle stream pre-stored in the local storage is downloaded from an external source.

18. The apparatus of claim 13, wherein the first player status register includes a flag indicating whether display of text subtitle streams is enable or disable.

19. The apparatus of claim 13, wherein the playback system further comprises a third player status register containing a third register value which indicates a language code of the text subtitle stream specified by the first register value.
